(19) United States
(12) Patent Application Publication
(10) Pub. No.: US 2023/0259328 A1
(43) Pub. Date: Aug. 17, 2023

(54) INFORMATION PROVISION SYSTEM, METHOD, AND NON-TRANSITORY COMPUTER-READABLE MEDIUM

(71) Applicants: JTEKT CORPORATION, Kariya-shi (JP); connectome.design Inc., Tokyo (JP)

(72) Inventors: Hiroki UMEZAWA, Nagoya-shi (JP); Yoshiyuki SHIBATA, Tokyo-shi (JP); Takashi MATSUMOTO, Kariya-shi (JP); Akira SATO, Chiyoda-ku (JP)

(73) Assignees: JTEKT CORPORATION, Kariya-shi (JP); connectome.design Inc., Tokyo (JP)

(21) Appl. No.: 18/169,458

(22) Filed: Feb. 15, 2023

(30) Foreign Application Priority Data
Feb. 16, 2022 (JP) 2022-021703

(51) Int. Cl. G06F 3/16; G06F 3/01

(52) U.S. Cl. CPC G06F 3/167; G06F 3/013; G06F 3/012

(57) ABSTRACT

An information provision system includes a processor and a memory storing instructions that, when executed by the processor, cause the information provision system to perform operations. The operations include: acquiring position information of a user and line-of-sight direction information of the user; estimating a target visually recognized by the user based on the position information, the line-of-sight direction information, and target position information for targets visually recognizable by the user; outputting, by sound, description information about the target in accordance with a setting; detecting a motion of a head of the user; estimating an intention of the user based on the motion during output of the description information; selecting the setting in accordance with the intention; and outputting, in response to change of the setting, the description information in accordance with the setting after the change.

### CROSS-REFERENCE TO RELATED APPLICATIONS

This application is based on and claims priority under 35 USC 119 from Japanese Patent Application No. 2022-021703 filed on Feb. 16, 2022, the contents of which are incorporated herein by reference.

### TECHNICAL FIELD

The present disclosure relates to an information provision system, a method, and a program.

### BACKGROUND ART

JPH08-160897A discloses a merchandise display shelf that includes a CD player and a speaker and provides a customer with information describing a merchandise. On the merchandise display shelf, a CD in which descriptions of displayed merchandises are recorded is reproduced by the CD player, and a reproduced sound is output from the speaker.

### SUMMARY OF INVENTION

In the display shelf disclosed in JPH08-160897A, descriptions of a plurality of merchandises are reproduced in a predetermined order. When a customer moves near the display shelf, if a merchandise that the customer is not interested in is described, information that the customer does not desire is provided. In addition, if the customer wants to hear the description of the merchandise of interest, the customer needs to wait for a while near the display shelf. Since the merchandise description is merely reproduced in the predetermined order, even if the customer misses part of the description, the part cannot be heard again immediately.

As described above, in the configuration according to JPH08-160897A, sound information in consideration of an intention of the customer cannot be provided.

The present disclosure can be implemented in the following forms.

(1) According to an aspect of the present disclosure, an information provision system is provided. The information provision system provides information by sound. The information provision system includes: a processor; and a memory storing instructions that, when executed by the processor, cause the information provision system to perform operations. The operations include: acquiring position information indicating a position where a user is present and line-of-sight direction information indicating a line-of-sight direction corresponding to a direction in which a face of the user faces; estimating a target visually recognized by the user based on the position information, the line-of-sight direction information, and target position information set in advance for each of a plurality of targets that are possible targets visually recognizable by the user; outputting, by sound, description information about the target in accordance with a setting related to information provision; detecting a motion of a head of the user; estimating an intention of the user based on the motion of the head of the user during output of the description information; selecting the setting in accordance with the intention of the user; and outputting, in response to change of the setting, the description information in accordance with the setting after the change.

According to such an aspect, the setting related to information provision is selected in accordance with the estimated intention of the user during output of the description information. The description information is provided to the user in accordance with the setting.

Therefore, it is possible to dynamically change the setting in accordance with the intention of the user. Accordingly, it is possible to provide sound information in consideration of the intention of the user.

(2) In the information provision system according to the above aspect, the description information may include first description information that is a description for the plurality of targets and second description information that is a description for the plurality of targets different from the first description information. The setting may include information indicating which of the first description information and the second description information is selected as the description information.

According to such an aspect, either the first description information or the second description information different from the first description information is selected in accordance with the estimated intention of the user while the description information is being output. Therefore, it is possible to provide the sound information in consideration of the intention of the user.

(3) In the information provision system according to the above aspect, the description information may further include third description information that is a description for the plurality of targets different from the first description information and the second description information, the first description information is a normal description for the plurality of targets, the second description information is a description more detailed than the first description information, and the third description information is a description simpler than the first description information. The setting includes information indicating which of the first description information, the second description information, and the third description information is selected as the description information.

According to such an aspect, any one of the normal description, the detailed description, and the simple description is selected in accordance with the estimated intention of the user while the description information is being output. Therefore, for example, when it is estimated that the user desires the simple description while the normal description is sound-output, the simple description is switched to be sound-output. In this way, it is possible to provide the sound information in consideration of the intention of the user.

(4) In the information provision system according to the above aspect, the setting may include setting information related to sound output.

According to such an aspect, the setting related to sound output is selected in accordance with the estimated intention of the user while the description information is being output. For example, when it is estimated that the user feels that the description information is difficult to hear, the setting is changed to increase a sound volume. Therefore, since the sound volume is increased while the description information is being output, the user can hear the description information at a sound volume at which the user can easily hear the description information. In this way, it is possible to provide the sound information in consideration of the intention of the user.

(5) In the information provision system according to the above aspect, the setting may include information indicating whether to continue the output of the description information.

According to such an aspect, whether to continue the output of the description information is selected in accordance with the estimated intention of the user while the description information is being output. For example, when it is estimated that the user feels that the output of the description information is unnecessary, the setting is changed so that the output of the description information is not continued. Therefore, the description information not desired by the user is not provided to the user.

(6) In the information provision system according to the above aspect, the operations may further include: outputting a question for the user by sound; and estimating an answer of the user to the question based on the motion of the head of the user.

According to such an aspect, it is possible to provide a participatory information provision system in which the user can participate and receive information rather than passively receiving information.

(7) In the information provision system according to the above aspect, the plurality of targets include a moving object. The operations may further include estimating that the moving object is the target visually recognized by the user in a case in which a state in which the moving object is present in a range in which eyes of the user can see continues for a preset period.

According to such an aspect, it is possible to provide the user with description information about not only a stationary object but also a moving object.

(8) In the information provision system according to the above aspect, the operations may further include: acquiring a virtual position of a sound source corresponding to each of the plurality of targets; and outputting, from a portable sound output device mountable on the head of the user, sound obtained by performing a stereophonic sound process on sound representing the description information in accordance with a virtual position of the sound source as viewed from a current position of the user.

According to such an aspect, it is possible to provide the user with information on a visually recognized target while giving the user a sense of presence.

(9) In the information provision system according to the above aspect, the operations may further include: acquiring intention definition data which defines a non-verbal motion based on a culture to which a language used by the user belongs; and estimating the intention of the user based on the intention definition data and the motion of the head of the user.

According to such an aspect, even the user speaks a different language, the intention of the user can be estimated based on the motion of the head.

(10) In the information provision system according to the above aspect, the operations may further include estimating the intention of the user by inputting, to a learned machine learning model, a parameter representing the motion of the head of the user, a moving speed of the user, a distance between the user and the target, and a relative angle of the user with respect to the target.

According to such an aspect, the intention of the user can be estimated with high accuracy.

Aspects in the present disclosure may be implemented in various forms other than the information provision system. For example, the present disclosure can be implemented by a method for providing information by sound using a computer carriable by a user, and a non-transitory computer-readable medium storing a computer program.

### BRIEF DESCRIPTION OF DRAWINGS

FIG. 1 is a diagram showing a schematic configuration of an information provision system according to an embodiment.

FIG. 2 is a diagram showing a method of representing a motion of a head of a user by a rotation angle.

FIG. 3 is a diagram showing a positional relationship between a user and a virtually disposed sound source.

FIG. 4 is a flowchart of an information provision process.

FIG. 5 is a flowchart of a description information output process.

FIG. 6 is a flowchart of a motion detection process.

FIG. 7 is a flowchart of an intention estimation process.

### DESCRIPTION OF EMBODIMENTS

### A. Embodiment

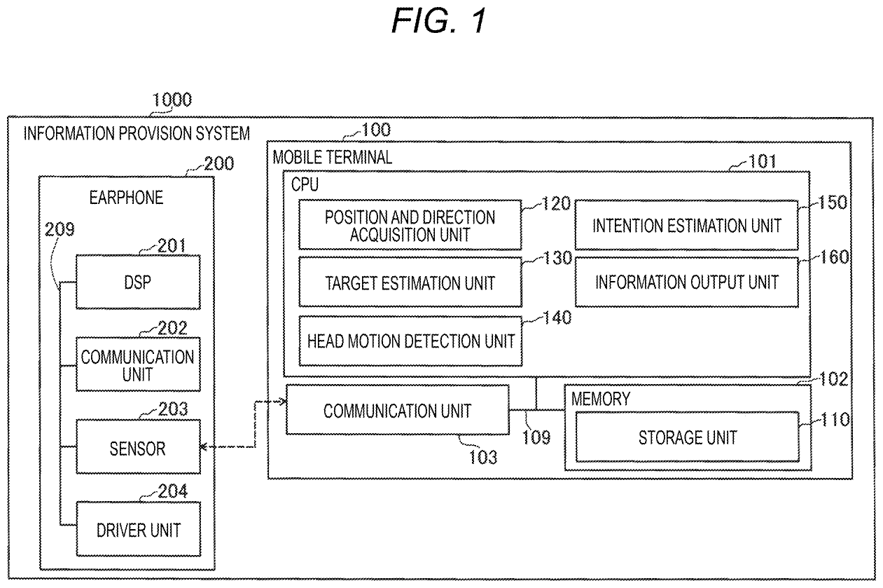

FIG. 1 is a diagram showing a configuration of an information provision system 1000 according to an embodiment. The information provision system 1000 provides a user with description information describing a target visually recognized by the user by sound. The information provision system 1000 provides information according to an estimated intention of the user. In the embodiment, an example in which the information provision system 1000 provides information on a tourist spot to a user who turns around the tourist spot will be described. The information provision system 1000 includes a mobile terminal 100 and an earphone 200.

The mobile terminal 100 is a communication terminal carried by a user. In the embodiment, the mobile terminal 100 is a smartphone owned by a user. It is assumed that application software for providing information on the tourist spot to the user is installed in the mobile terminal 100. Hereinafter, the application software is referred to as a guidance application. The user can receive information on the tourist spot from the information provision system 1000 by executing the guidance application. It is assumed that the user carries the mobile terminal 100 and turns around the tourist spot. The guidance application has a function of estimating a current position of the user and a target visually recognized by the user and providing information on the tourist spot to the user. The mobile terminal 100 is also referred to as a computer carried by the user.

The earphone 200 is a portable sound output device worn on the head of the user. The earphone 200 is a portable sound output device that outputs sound representing a signal received from the mobile terminal 100. In the embodiment, the earphone 200 is a wireless earphone owned by the user. It is assumed that the user wears the earphone 200 on his ear and turns around the tourist spot.

The mobile terminal 100 includes, as a hardware configuration, a central processing unit (CPU) 101, a memory 102, and a communication unit 103. The memory 102 and the communication unit 103 are coupled to the CPU 101 via an internal bus 109.

The CPU 101 executes various programs stored in the memory 102 to implement the functions of the mobile terminal 100. The memory 102 stores the programs executed by the CPU 101 and various types of data used for executing the programs. The memory 102 is used as a work memory of the CPU 101.

The communication unit 103 includes a network interface circuit, and communicates with an external device under control of the CPU 101. In the embodiment, it is assumed that the communication unit 103 can communicate with the external device according to a communication standard of Wi-Fi (registered trademark). Further, the communication unit 103 includes a global navigation satellite system (GNSS) receiver, and receives a signal from a positioning satellite under the control of the CPU 101. In the information provision system 1000, a global positioning system (GPS) is used as the GNSS.

The earphone 200 outputs the sound representing the signal supplied from the mobile terminal 100. The earphone 200 includes a digital signal processor (DSP) 201, a communication unit 202, a sensor 203, and a driver unit 204. The communication unit 202, the sensor 203, and the driver unit 204 are coupled to the DSP 201 via an internal bus 209.

The DSP 201 controls the communication unit 202, the sensor 203, and the driver unit 204. The DSP 201 outputs a sound signal received from the mobile terminal 100 to the driver unit 204. The DSP 201 transmits a measurement value to the mobile terminal 100 each time the measurement value is supplied from the sensor 203. The communication unit 202 includes a network interface circuit, and communicates with an external device under control of the DSP 201. The communication unit 202 wirelessly communicates with the mobile terminal 100 according to, for example, the Bluetooth (registered trademark) standard.

The sensor 203 includes an acceleration sensor, an angle sensor, and an angular velocity sensor. For example, a three-axis acceleration sensor is used as the acceleration sensor. A three-axis angular velocity sensor is used as the angular velocity sensor. The sensor 203 performs measurement at predetermined time intervals, and outputs, to the DSP 201, a measurement value of the measured acceleration and a measurement value of the measured angular velocity. The driver unit 204 converts the sound signal supplied from the DSP 201 into a sound wave and outputs the sound wave.

The mobile terminal 100 functionally includes a storage unit 110, a position and direction acquisition unit 120, a target estimation unit 130, a head motion detection unit 140, an intention estimation unit 150, and an information output unit 160.

The storage unit 110 stores, for example, position coordinates indicating positions of an art museum, a park, an observation platform, or the like as position information of a location that the user may visit. The position information of the location where the user may visit is also referred to as location position information. The storage unit 110 stores, for example, position coordinates representing a position of an exhibition in an art museum as position information of a target that can be a target visually recognized by the user. The position information of a target that can be a target visually recognized by the user is also referred to as target position information. Further, the storage unit 110 stores, for example, sound source data having a sound signal obtained by reading information describing an exhibition in an art museum as description information describing a target that can be a target visually recognized by the user. Further, the storage unit 110 stores information indicating a position at which the sound source, which will be described later, is virtually disposed, for each target that can be a target visually recognized.

The storage unit 110 stores intention definition data that associates a motion of a head of the user with an intention of the user. An example of the association between the motion of the head of the user and the intention defined in the intention definition data will be described below. A head-tilting motion of the user indicates that the user cannot understand. Repetition of the head-tilting motion of the user indicates that the user cannot hear well. A nodding motion of the user indicates that the user has an affirmative feeling. A head-shaking motion of the user indicates that the user has a negative feeling. Repetition of the head-shaking motion of the user indicates that the user has a more negative feeling.

The storage unit 110 stores setting data representing an information-provision-related setting. The information-provision-related setting represents a setting when the description information is output by sound. In the embodiment, the information-provision-related setting includes information indicating selection of a type of the description information, information indicating a volume of the sound from which the description information is output, information indicating whether to execute frame-back of the description information, and information indicating whether to continue the output of the description information.

In the information provision system 1000, the description information provided to the user is any one of three types of description information including normal description information, detailed description information, and simple description information. For example, it is assumed that description information about a target T1 is provided to the user. The normal description information is information describing the target T1 that is usually scheduled to be provided to the user. The detailed description information is information describing the target T1 in more detail than the normal description information. The simple description information is information describing the target T1 more easily than the normal description information. The normal description information is also referred to as first description information. The detailed description information is also referred to as second description information, and the simple description information is also referred to as third description information. The detailed description information is also referred to as the third description information, and the simple description information is also referred to as the second description information. The information indicating the selection of the type of the description information indicates which of the normal description information, the detailed description information, and the simple description information is selected.

The information indicating the volume of the sound from which the description information is output represents the volume of the sound output from the earphone 200. The setting of whether to execute the frame-back of the description information is to set whether to execute the frame-back with respect to a part of the description information that was sound-output immediately before. The frame-back refers to re-outputting the part of the description information that was sound-output. The information indicating whether to continue the output of the description information indicates whether to continue the output of the description information by sound or to stop the output in the middle. The information indicating the volume of the sound at which the description information is output is also referred to as sound-output-related setting information.

The functions of the storage unit 110 are implemented by the memory 102. The location position information, the target position information, the description information, and the information indicating the position of the sound source are stored in the memory 102 as a part of data for executing the guidance application when the guidance application is installed in the mobile terminal 100.

The position and direction acquisition unit 120 acquires information indicating a current position of the mobile terminal 100 as information indicating a current position of the user. Further, the position and direction acquisition unit 120 acquires information indicating a line-of-sight direction of the user based on the measurement value obtained by the sensor 203. Functions of the position and direction acquisition unit 120 are implemented by the CPU 101.

The target estimation unit 130 estimates a target visually recognized by the user. A method of estimating the target visually recognized by the user will be described later. Functions of the target estimation unit 130 are implemented by the CPU 101.

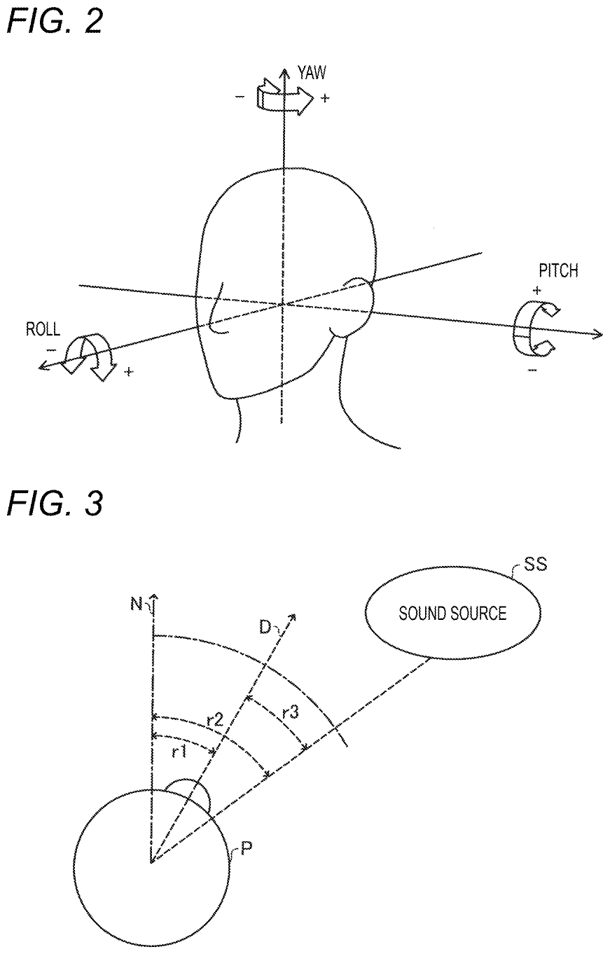

FIG. 2 is a diagram showing a method of detecting the motion of the head of the user. The head motion detection unit 140 detects the motion of the head of the user wearing the earphone 200. In the embodiment, the motion of the head of the user is represented by a rotation angle. A rotation axis along a front-back direction of the user is defined as a roll axis, a rotation axis along a left-right direction of the user is defined as a pitch axis, and a rotation axis along a gravity direction is defined as a yaw axis. The head-tilting motion of the user can be represented as a rotation about the roll axis. The nodding motion of the user can be represented as a rotation about the pitch axis. A turning motion of the user can be represented as a rotation about the yaw axis.

Hereinafter, a displacement amount of the rotation angle about the roll axis may be referred to as a roll angle, a displacement amount of the angle about the pitch axis may be referred to as a pitch angle, and a displacement amount of the angle about the yaw axis may be referred to as a yaw angle. The motion of the head of the user is represented by the roll angle, the pitch angle, and the yaw angle. A range of the roll angle is from +30 degrees to −30 degrees when the user facing forward is set as 0 degrees. A range of the pitch angle is from +45 degrees to −45 degrees when the user facing forward is set as 0 degrees. A range of the yaw angle is from +60 degrees to −60 degrees when the user facing forward is set as 0 degrees.

The head motion detection unit 140 detects the roll angle, the pitch angle, and the yaw angle based on a measurement value of an acceleration and a measurement value of an angular velocity measured by the sensor 203. The head motion detection unit 140 supplies information indicating detection results of the roll angle, the pitch angle, and the yaw angle to the intention estimation unit 150. Functions of the head motion detection unit 140 are implemented by the CPU 101.

The intention estimation unit 150 identifies the motion of the head of the user based on the roll angle, the pitch angle, and the yaw angle detected by the head motion detection unit 140. Then, the intention estimation unit 150 estimates the intention of the user based on the identified motion of the head of the user and the intention definition data. Further, the intention estimation unit 150 selects an information-provision-related setting in accordance with the estimated intention of the user. In some cases, the information-provision-related setting is not changed in accordance with the estimated intention of the user. In such a case, the intention estimation unit 150 selects to maintain the current setting. Functions of the intention estimation unit 150 are implemented by the CPU 101.

When the target estimation unit 130 estimates a target visually recognized by the user, the information output unit 160 outputs, by the earphone 200, sound of the description information describing the estimated target in accordance with the information-provision-related setting stored in the storage unit 110. Specifically, the information output unit 160 outputs, by the earphone 200, the description information of a selected type at a sound volume designated in the information-provision-related setting.

It is assumed that, after the output of the description information is started, the information-provision-related setting is changed in accordance with the estimated intention of the user. In this case, the information output unit 160 outputs, by the earphone 200, the description information in accordance with the changed information-provision-related setting.

FIG. 3 is a diagram showing a positional relationship between a user P and a virtually disposed sound source SS. FIG. 3 shows a state in which the user P and the sound source SS are viewed from above. In the embodiment, the information output unit 160 outputs, from the earphone 200, sound of reading out the description information with stereophonic sound. A position of the sound source SS is set to a position same as the visually recognized target. First, the information output unit 160 reads, from the storage unit 110, information on the position at which the sound source SS is virtually disposed with respect to the estimated visually recognized target. The information output unit 160 acquires the virtual position of the sound source by reading, from the storage unit 110, information indicating the position at which the sound source with respect to the visually recognized target is virtually disposed. The information output unit 160 is also referred to as a sound source position acquisition unit.

Further, the information output unit 160 obtains a relative angle of a direction in which the sound source SS is located as viewed from the user P with respect to a line-of-sight direction D of the user P. In a horizontal plane, a magnitude of an angle formed by the line-of-sight direction D with respect to a reference direction N is an angle r1. The reference direction N is, for example, a direction facing north. A magnitude of an angle formed by the direction in which the sound source SS is located as viewed from the user P with respect to the reference direction N is an angle r2. The information output unit 160 obtains the angle r1 from the line-of-sight direction D and the reference direction N. The information output unit 160 obtains the angle r2 based on the position of the sound source SS, the position of the user P, and the reference direction N. The information output unit 160 obtains an angle r3, which is a difference between the angle r1 and the angle r2, as a relative angle of the direction in which the sound source SS is located with respect to the line-of-sight direction D of the user P.

Next, the information output unit 160 obtains a distance between the user P and the sound source SS based on the position of the user P and the position of the sound source SS. The information output unit 160 outputs, by the earphone 200, and based on the obtained angle and distance, the sound obtained by performing a stereophonic sound process thereon. In the stereophonic sound process, for example, an existing algorithm for generating stereophonic sound is used. Functions of the information output unit 160 are implemented by the CPU 101.

For example, it is assumed that a central portion of a picture displayed in an art museum is set as a position of a virtual sound source. In this case, a user viewing the picture can feel that the sound of the description information is being output from the central portion of the picture. As described above, in the embodiment, it is possible to provide the user with information on a visually recognized target while giving the user a sense of presence.

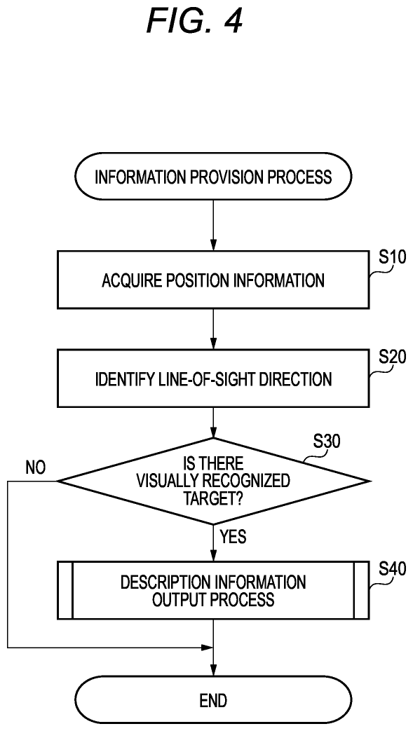

FIG. 4 is a flowchart of an information provision process in which the information provision system 1000 provides information to the user via the mobile terminal 100. The information provision process is started at predetermined time intervals. The determined time interval is, for example, 0.5 seconds. Even when the predetermined time elapses, if the information provision process started immediately before is not ended in the same mobile terminal 100, it is assumed that a new information provision process is not started. It is assumed that, at a time point when the information provision process is started, information indicating the information-provision-related setting stored in the storage unit 110 is initial setting information.

In step S10, the position and direction acquisition unit 120 acquires position information of the mobile terminal 100. Specifically, first, the position and direction acquisition unit 120 acquires position coordinates indicating the current position of the mobile terminal 100 based on a GPS signal received from a GPS satellite. When the GPS signal cannot be received, the position and direction acquisition unit 120 acquires the position coordinates indicating the current position of the mobile terminal 100 based on radio wave intensities received from a plurality of Wi-Fi (registered trademark) base stations. The position and direction acquisition unit 120 supplies the position coordinates of the mobile terminal 100 to the target estimation unit 130.

In step S20, the position and direction acquisition unit 120 identifies a line-of-sight direction of the user. The position and direction acquisition unit 120 determines whether the user is gazing at something based on the measurement value of the acceleration and the measurement value of the angular velocity measured by the sensor 203. For example, when the measurement value of the acceleration satisfies a predetermined condition and the measurement value of the angular velocity satisfies a predetermined condition, the position and direction acquisition unit 120 determines that the user is gazing at something. When it is determined that the user is gazing at something, the position and direction acquisition unit 120 identifies a direction in which a face of the user faces based on the acceleration and the angular velocity.

The direction in which the face of the user faces can be represented by an azimuth angle and an elevation angle or a depression angle. Here, the azimuth angle refers to an angle formed by the direction in which the face of the user faces with respect to a reference direction. The elevation angle refers to an angle formed by a line-of-sight direction of the user viewing an upper target with respect to a horizontal plane. The depression angle refers to an angle formed by a line-of-sight direction of the user viewing a lower target with respect to the horizontal plane. In the embodiment, the direction in which the face of the user faces is defined as the line-of-sight direction of the user. Information indicating the line-of-sight direction of the user is also referred to as line-of-sight direction information. The position and direction acquisition unit 120 supplies the line-of-sight direction information indicating the line-of-sight direction of the user to the target estimation unit 130.

On the other hand, when the position and direction acquisition unit 120 determines that the user is not gazing at something, the position and direction acquisition unit 120 notifies the target estimation unit 130 that the line-of-sight direction cannot be identified.

In step S30, the target estimation unit 130 determines whether there is a target visually recognized by the user. Specifically, first, the target estimation unit 130 reads, from the storage unit 110, position information on the target that is within a preset range centered on the current position of the user indicated by the position information supplied from the position and direction acquisition unit 120, as information on candidates of the visually recognized target. The target estimation unit 130 determines whether any one of the candidates of the visually recognized target is present in a visual field range of the user based on the position information on the target within the set range and the position information and the line-of-sight direction information supplied from the position and direction acquisition unit 120. It is assumed that the visual field range of the user is preset for each of the azimuth angle, the elevation angle, and the depression angle.

For example, it is assumed that the target estimation unit 130 determines that a target T1 is present in the visual field of the user. In this case, the target estimation unit 130 determines whether a state in which the target T1 is present in the visual field of the user continues for a preset period. The preset period is, for example, one second. The target estimation unit 130 determines that the user is visually recognizing the target T1 when the state in which the target T1 is present in the visual field of the user continues for the preset period. When it is determined that there is the visually recognized target (step S30; YES), the target estimation unit 130 supplies information indicating the determined target to the information output unit 160.

On the other hand, when the target estimation unit 130 determines that the visually recognized target cannot be estimated (step S30; NO), the information provision process is ended. For example, when the target estimation unit 130 is notified from the position and direction acquisition unit 120 that the line-of-sight direction of the user cannot be identified, the target estimation unit 130 determines that the visually recognized target cannot be estimated. The target estimation unit 130 determines that the visually recognized target cannot be estimated when the state in which the target T1 is present in the visual field of the user is not continued for the preset period. When there is no target that can be a target visually recognized within the preset range centered on the current position of the user, the target estimation unit 130 determines that the visually recognized target cannot be estimated.

In step S40, a description information output process of outputting the description information on the estimated target by sound is executed. Thereafter, the process shown in FIG. 4 is ended.

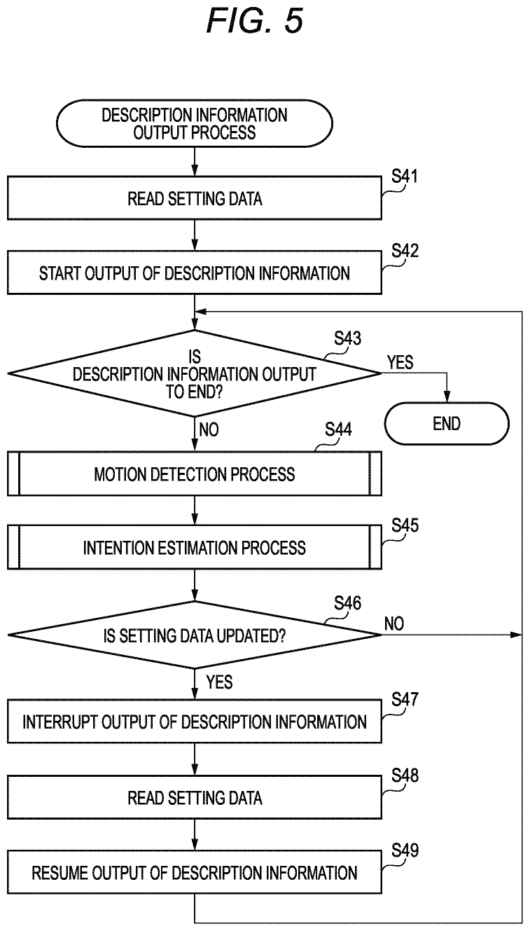

FIG. 5 is a flowchart of the description information output process in step S40 in FIG. 4. In step S41, the information output unit 160 reads information-provision-related setting data stored in the storage unit 110.

In step S42, the information output unit 160 reads the description information related to the estimated visually recognized target from the storage unit 110, and starts sound output of the description information via the earphone 200.

In step S43, the information output unit 160 determines whether the description information is output to the end. When the description information is not output to the end (step S43; NO), the process in step S44 is executed. On the other hand, when the description information is output to the end (step S43; YES), the description information output process is ended.

In step S44, a motion detection process is executed by the head motion detection unit 140. In the motion detection process, a motion of the head of the user in a preset period is detected.

In step S45, an intention estimation process is executed by the intention estimation unit 150. In the intention estimation process, the intention of the user is estimated based on the motion of the head of the user. Further, an information-provision-related setting is selected in accordance with the intention of the user.

In step S46, the information output unit 160 determines whether the information-provision-related setting data is updated based on a notification from the intention estimation unit 150. When the information-provision-related setting data is updated (step S46; YES), the information output unit 160 executes a process in step S47. On the other hand, when the information-provision-related setting data is not updated (step S46; NO), the process in step S43 is executed.

In step S47, the information output unit 160 interrupts the output of the description information. In step S48, the information output unit 160 reads the information-provision-related setting data from the storage unit 110. In step S49, the information output unit 160 starts outputting the description information again in accordance with the information-provision-related setting data after the update. Thereafter, the process in step S43 is executed again.

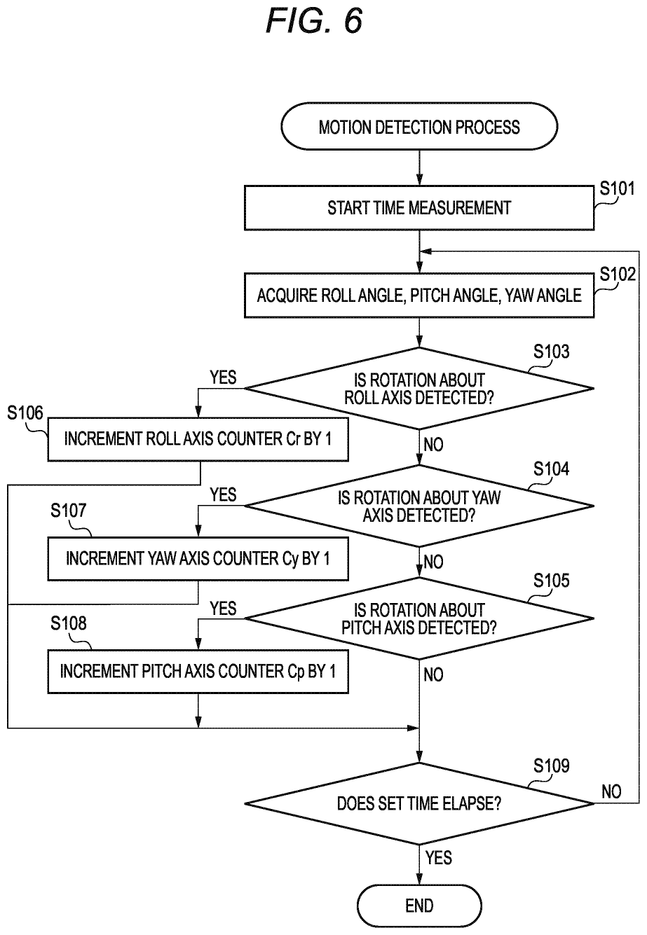

FIG. 6 is a flowchart of the motion detection process shown in step S44 in FIG. 5. In step S101, the head motion detection unit 140 starts a timer and starts time measurement. In the embodiment, in order to estimate the intention of the user, the motion of the head of the user is observed for a set period. The set period is, for example, 0.5 seconds. The timer is used to measure the set period.

In step S102, the head motion detection unit 140 acquires a roll angle, a pitch angle, and a yaw angle representing the motion of the head of the user. Specifically, the head motion detection unit 140 calculates, based on the measurement value of the acceleration and the measurement value of the angular velocity measured by the sensor 203, the roll angle, the pitch angle, and the yaw angle representing the motion of the head of the user.

In step S103, the head motion detection unit 140 determines whether rotation about the roll axis is detected. For example, when the roll angle is equal to or greater than a predetermined rotation angle, the head motion detection unit 140 determines that the rotation about the roll axis is detected. When the rotation about the roll axis is detected (step S103; YES), the head motion detection unit 140 executes a process in step S106. On the other hand, in step S103, when the head motion detection unit 140 determines that the rotation about the roll axis is not detected (step S103; NO), the head motion detection unit 140 executes a process in step S104.

In step S104, the head motion detection unit 140 determines whether rotation about the yaw axis is detected. For example, when the yaw angle is equal to or greater than the predetermined rotation angle, the head motion detection unit 140 determines that the rotation about the yaw axis is detected. When the rotation about the yaw axis is detected (step S104; YES), the head motion detection unit 140 executes a process in step S107. On the other hand, in step S104, when the head motion detection unit 140 determines that the rotation about the yaw axis is not detected (step S104; NO), the head motion detection unit 140 executes a process in step S105.

In step S105, the head motion detection unit 140 determines whether rotation about the pitch axis is detected. For example, when the pitch angle is equal to or greater than the predetermined rotation angle, the head motion detection unit 140 determines that the rotation about the pitch axis is detected. When the rotation about the pitch axis is detected (step S105; YES), the head motion detection unit 140 executes a process in step S108. On the other hand, in step S105, when the head motion detection unit 140 determines that the rotation about the pitch axis is not detected (step S105; NO), the head motion detection unit 140 executes a process in step S109.

In step S106, the head motion detection unit 140 increments a roll axis counter Cr by 1. The head motion detection unit 140 resets a yaw axis counter Cy and a pitch axis counter Cp. Thereafter, the head motion detection unit 140 executes the process in step S109. The roll axis counter Cr is a counter indicating the number of times the rotation about the roll axis is detected. The yaw axis counter Cy is a counter indicating the number of times the rotation about the yaw axis is detected. The pitch axis counter Cp is a counter indicating the number of times the rotation about the pitch axis is detected.

In step S107, the head motion detection unit 140 increments the yaw axis counter Cy by 1. The head motion detection unit 140 resets the roll axis counter Cr and the pitch axis counter Cp. Thereafter, the head motion detection unit 140 executes the process in step S109.

In step S108, the head motion detection unit 140 increments the pitch axis counter Cp by 1. The head motion detection unit 140 resets the roll axis counter Cr and the yaw axis counter Cy. Thereafter, the head motion detection unit 140 executes the process in step S109.

In step S109, the head motion detection unit 140 determines whether a preset time elapses since the timer is started. When the set time elapses (step S109; YES), the head motion detection unit 140 stops the timer and ends the motion detection process. On the other hand, when the set time does not elapse (step S109; NO), the process in step S102 is executed again.

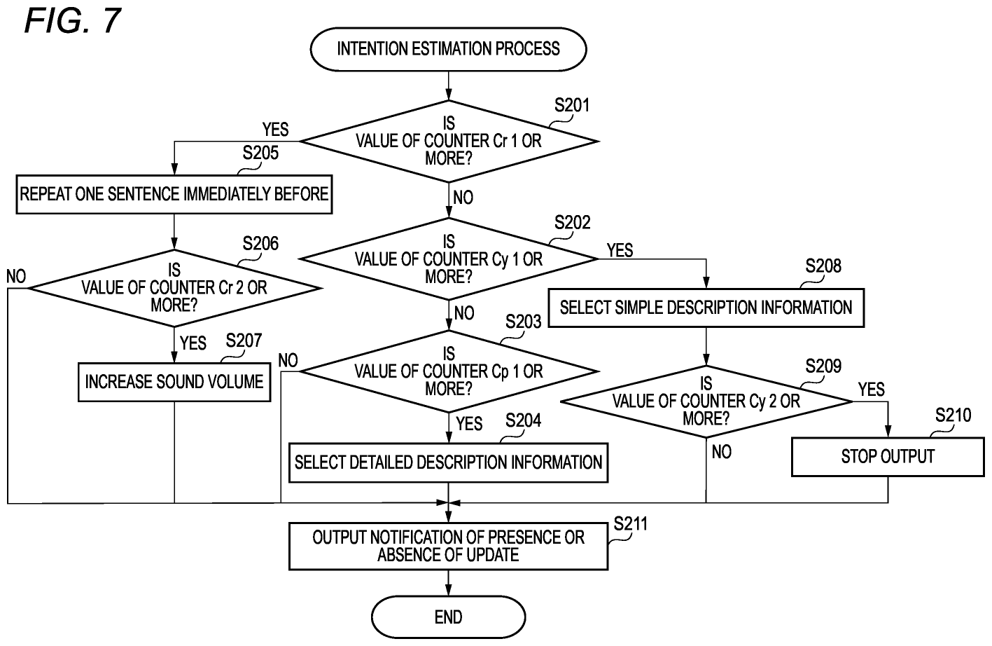

FIG. 7 is a flowchart of the intention estimation process in step S45 in FIG. 5. In step S201, the intention estimation unit 150 determines whether a value of the roll axis counter Cr is 1 or more. When the value of the roll axis counter Cr is 1 or more (step S201; YES), the intention estimation unit 150 executes a process in step S205. On the other hand, when the value of the roll axis counter Cr is not 1 or more (step S201; NO), the intention estimation unit 150 executes a process in step S202.

In step S202, the intention estimation unit 150 determines whether a value of the yaw axis counter Cy is 1 or more. When the value of the yaw axis counter Cy is 1 or more (step S202; YES), the intention estimation unit 150 executes a process in step S208. On the other hand, when the value of the yaw axis counter Cy is not 1 or more (step S202; NO), the intention estimation unit 150 executes a process in step S203.

In step S203, the intention estimation unit 150 determines whether a value of the pitch axis counter Cp is 1 or more. When the value of the pitch axis counter Cp is 1 or more (step S203; YES), the intention estimation unit 150 executes a process in step S204. On the other hand, when the value of the pitch axis counter Cp is not 1 or more (step S203; NO), the intention estimation unit 150 executes a process in step S211.

In step S204, the intention estimation unit 150 selects detailed description information as the description information. The intention estimation unit 150 updates the information-provision-related setting data stored in the storage unit 110 with a selected content. Thereafter, the intention estimation unit 150 executes the process in step S211.

In step S205, the intention estimation unit 150 selects execution of the frame-back of the description information. The intention estimation unit 150 updates the information-provision-related setting data stored in the storage unit 110 with a selected content. Thereafter, the intention estimation unit 150 executes a process in step S206.

In step S206, when the value of the counter Cr is 2 or more (step S206; YES), the intention estimation unit 150 executes a process in step S207. On the other hand, when the value of the counter Cr is not 2 or more (step S206; NO), the intention estimation unit 150 executes the process in step S211.

In step S207, the intention estimation unit 150 updates the information-provision-related setting data stored in the storage unit 110 to increase a value of the volume of the output sound by a preset value. Thereafter, the intention estimation unit 150 executes the process in step S211.

In step S208, the intention estimation unit 150 selects simple description information as the description information. The intention estimation unit 150 updates the information-provision-related setting data with the selected content. Thereafter, the intention estimation unit 150 executes a process in step S209.

In step S209, when the value of the counter Cy is 2 or more (step S209; YES), the intention estimation unit 150 executes a process in step S210. On the other hand, when the value of the counter Cy is not 2 or more (step S209; NO), the intention estimation unit 150 executes the process in step S211.

In step S210, the intention estimation unit 150 selects to stop the output of the description information in the middle. The intention estimation unit 150 updates the information-provision-related setting data with the selected content. Thereafter, the intention estimation unit 150 executes the process in step S211.

In step S211, the intention estimation unit 150 notifies the information output unit 160 of whether the information-provision-related setting data is updated. Then, the intention estimation process is ended. Thereafter, the process in step S46 shown in FIG. 5 is executed.

When the detailed description information is selected in the information-provision-related setting data after the update, the information output unit 160 reads the detailed description information on the visually recognized target from the storage unit 110. The information output unit 160 resumes the output of the detailed description information to the earphone 200. The information output unit 160 outputs the description information from a position in the detailed version corresponding to a position interrupted immediately before. In response to this, the earphone 200 resumes the output of the detailed description information from the interrupted location.

For example, when the user nods while the normal description information is provided to the user, it is considered that the user has an affirmative feeling about the description information. In this case, it is considered that the user wants to hear a more detailed description. With the configuration according to the embodiment, it is possible to switch to provide the detailed description information in accordance with the estimated intention of the user. In this way, it is possible to provide the sound information in consideration of the intention of the user.

When the execution of the frame-back of the description information is selected in the information-provision-related setting data after the update, the information output unit 160 re-outputs, by the earphone 200, a part of the description information output immediately before. In response to this, the earphone 200 outputs, for example, one sentence output immediately before by sound. Thereafter, the information output unit 160 resumes the output of the description information from the position interrupted immediately before. In response to this, earphone 200 resumes the output of the description information from the interrupted location.

For example, when the user tilts his/her head, it is considered that the user missed hearing the description information immediately before. In this case, a part of the description information output immediately before is re-output. Therefore, the user can hear the missing part again. In this way, it is possible to provide the sound information in consideration of the intention of the user.

When the value of the volume of the output sound is increased in the information-provision-related setting data after the update, the information output unit 160 resumes the output of the description information to the earphone 200 together with an instruction to designate the sound volume after the update. In response to this, the earphone 200 resumes the output of the description information at the sound volume after the update.

For example, when the user repeatedly tilts his/her head, it is considered that the user feels that the description information cannot be heard well. In this case, in the configuration according to the embodiment, the setting is changed to increase the sound volume. Therefore, since the sound volume is increased while the description information is being output, the user can easily hear the description information. In this way, it is possible to provide the sound information in consideration of the intention of the user.

When the simple description information is selected in the information-provision-related setting data after the update, the information output unit 160 reads the simple description information on the visually recognized target from the storage unit 110. The information output unit 160 resumes the output of the simple description information to the earphone 200. The information output unit 160 outputs the description information from a position in the simple version corresponding to a position interrupted immediately before. In response to this, the earphone 200 resumes the output of the simple description information from the interrupted location.

For example, when the user shakes his/her head while the normal description information is provided to the user, it is considered that the user has a negative feeling toward the description information. In this case, it is considered that the user desires a simple description. With the configuration according to the embodiment, it is possible to switch to provide the simple description information in accordance with the estimated intention of the user. In this way, it is possible to provide the sound information in consideration of the intention of the user.

When the stop of the output of the description information is selected in the information-provision-related setting data after the update, the information output unit 160 stops the output of the description information. Accordingly, the output of the description information from the earphone 200 is not resumed.

For example, when the user repeatedly shakes his/her head, it is considered that the user has a negative feeling toward the description information. In this case, it is considered that the user does not desire the provision of the description information. With the configuration according to the embodiment, it is possible to switch the setting to stop the provision of the description information in accordance with the estimated intention of the user. Therefore, the description information not desired by the user is not provided to the user.

As described above, in the information provision system 1000, the information-provision-related setting is selected in accordance with the estimated intention of the user while the description information is being output. The description information is provided to the user in accordance with the information-provision-related setting. Therefore, it is possible to dynamically change the information-provision-related setting in accordance with the intention of the user. Accordingly, it is possible to provide sound information in consideration of the intention of the user.

### B1. Other Embodiment 1

In the embodiment, an example in which the user visually recognizes a target whose position is fixed is described. However, the target visually recognized by the user may be a moving object. The moving object is, for example, a ship or an airplane. In the information provision system 1000, for example, when the user is looking at a ship that sails on the sea from an observation platform in a park having the observation platform, the information provision system 1000 can sound-output the description information about the ship. In addition, for example, when the user is looking at an airplane after departure from and landing on an observation deck of the airport, the information provision system 1000 can sound-output the description information about the airplane. Hereinafter, configurations different from those in the embodiment will be mainly described.

In Other Embodiment 1, it is assumed that identified area information indicating a range of an identified area in which the user may visually recognize a moving object is stored in advance in the storage unit 110. The identified area is, for example, an observation platform of a park or an observation deck of an airport.

For example, it is assumed that the user is looking at a ship that sails on the sea from the observation platform in the park having the observation platform. The position and direction acquisition unit 120 acquires information indicating a current position of the mobile terminal 100 as information indicating a current position of the user. Further, the position and direction acquisition unit 120 acquires information indicating the line-of-sight direction of the user. The position and direction acquisition unit 120 identifies a direction in which the face of the user faces as the line-of-sight direction of the user based on a measurement value of the acceleration and a measurement value of the angular velocity received from the earphone 200.

The target estimation unit 130 estimates a target visually recognized by the user. Specifically, first, the target estimation unit 130 determines whether the user is within the range of the identified area based on the position information supplied from the position and direction acquisition unit 120 and the identified area information stored in the storage unit 110. When the target estimation unit 130 determines that the user is within the range of the identified area, the target estimation unit 130 determines a candidate of the target that may be visually recognized by the user based on the current position of the user, a date and time, a flight schedule, and route information. Further, the target estimation unit 130 determines whether the user is visually recognizing the candidate of the visually recognized target. When a state in which the target determined as the candidate of the visually recognized target is within the visual field range of the user is continued for a preset period, the target estimation unit 130 determines that the user 30 is visually recognizing the target determined as the visually recognized candidate. The visual field of the user is also referred to as a range in which eyes of the user can see.

When the target estimation unit 130 estimates the target visually recognized by the user, the information output unit 160 outputs the description information describing the estimated target from the earphone 200. The information output unit 160 acquires a position of a virtual sound source as follows. The information output unit 160 outputs, from the earphone 200, and based on a distance between the user and the visually recognized target and a relative angle of a direction of the visually recognized target as viewed from the user, sound obtained by performing a stereophonic sound process thereon. Since the visually recognized target is moving, the information output unit 160 may calculate the position of the target as the position of the virtual sound source at each predetermined time. The determined time is, for example, 5 seconds. The information output unit 160 may output the sound obtained by the stereophonic sound based on a distance between the newly calculated position of the sound source and the user and the relative angle of the direction in which the sound source is located as viewed from the user with respect to the line-of-sight direction of the user. In this case, the user can also feel that the description information is being output from the visually recognized target.

When a plurality of targets are present in the visual field of the user, for example, the information output unit 160 may output the description information in order from a target closer to the user to a target farther from the user.

The intention estimation unit 150 identifies the motion of the head of the user based on a detection result of the head motion detection unit 140, and estimates the intention of the user based on the identified motion of the head of the user and the intention definition data. The intention estimation unit 150 selects the information-provision-related setting in accordance with the estimated intention of the user while the description information is being output.

On the other hand, it is assumed that the target estimation unit 130 determines that the user is not within the range of the identified area based on the position information supplied from the position and direction acquisition unit 120 and the identified area information stored in the storage unit 110. In this case, in the information provision system 1000, the description information on the target whose position is fixed is provided to the user as in the embodiment.

### B2. Other Embodiment 2

A target visually recognized by the user may be a star. For example, when the user is outdoors and an elevation angle representing a line-of-sight direction of the user is within a preset range in a night time zone, the information provision system 1000 can sound-output the description information about constellations. In this case, the target estimation unit 130 may determine a target visually recognized by the user based on a current position of the user, a date and time, a line-of-sight direction of the user, and a starry diagram associated with the direction and the date and time. The target estimation unit 130 may read starry diagram data stored in advance in the storage unit 110. Alternatively, the target estimation unit 130 may read the starry diagram data stored in a cloud server.

### B3. Other Embodiment 3

In the embodiment, a user merely hears the description information about a target visually recognized by the user. However, the description information may include a question for the user. For example, the information output unit 160 of the mobile terminal 100 outputs a quiz for the visually recognized target by sound. Further, the information output unit 160 sequentially outputs, by sound, answer options together with numbers indicating the options. When the user nods after the number indicating any option is output, the intention estimation unit 150 may determine that the option selected by the user is the option indicated by the number.

According to such an aspect, it is possible to provide a participatory information provision system in which the user can participate and receive information rather than passively receiving information.

### B4. Other Embodiment 4

In the embodiment, when the user performs a nodding motion, the mobile terminal 100 determines that the user is affirmative. However, depending on a culture to which a language used by the user belongs, a non-verbal motion that means affirmative may be different. The non-verbal motion is a so-called gesture. Depending on the culture to which the language used by the user belongs, for example, shaking the head vertically can mean denial.

Therefore, the storage unit 110 of the mobile terminal 100 may store in advance intention definition data defined for each language to be used. The intention estimation unit 150 may estimate the intention of the user indicated by the motion of the head of the user based on the intention definition data corresponding to the language used by the user. The intention estimation unit 150 can acquire information on the language used by the user from, for example, setting information on the language set in the mobile terminal 100. As described above, even if the user speaks a different language, the intention of the user can be estimated based on the motion of the head.

### B5. Other Embodiment 5

In the embodiment, the intention estimation unit 150 estimates the intention of the user based on the identified motion of the head of the user and the intention definition data. Alternatively, the intention estimation unit 150 may estimate the intention of the user using a machine-learned machine learning model. The machine learning model outputs a result of estimating the intention of the user when a parameter representing the motion of the head of the user, a moving speed of the user, a distance between the user and a target, and a relative angle of the user with respect to the target are input. According to such an aspect, the intention of the user can be estimated with high accuracy.

### B6. Other Embodiment 6

In the embodiment, when a rotation angle of a certain rotation axis is equal to or greater than a predetermined rotation angle, the intention estimation unit 150 determines that rotation about the rotation axis is detected. However, there are cases where rotations on two rotation axes are detected at the same timing. In such a case, the intention estimation unit 150 may adopt the rotation of the rotation axis having a larger rotation angle.

### B7. Other Embodiment 7

The information-provision-related setting stored in the storage unit 110 may include information indicating a readout speed of the description information, in addition to the information described in the embodiment. The information indicating the readout speed of the description information represents a readout speed of the sound that reads out the description information output from the earphone 200. The information indicating the readout speed of the description information is also referred to as sound-output-related setting information.

For example, when the intention estimation unit 150 estimates that the user feels that it is difficult to hear the description information, the intention estimation unit 150 may update the information indicating the readout speed of the description information to slow down the readout speed of the description information.

### B8. Other Embodiment 8

In the embodiment, an example is described in which the position and direction acquisition unit 120 acquires information indicating the current position of the mobile terminal 100 indoors based on radio wave intensities received from a plurality of Wi-Fi (registered trademark) base stations. Alternatively, the position information on the mobile terminal 100 indoors may be acquired as follows. It is assumed that the mobile terminal 100 includes a geomagnetic sensor. In this case, the position and direction acquisition unit 120 may acquire the position information on the mobile terminal 100 using the geomagnetic sensor.

Alternatively, the position and direction acquisition unit 120 first acquires the position information on the mobile terminal 100 based on the radio wave intensities received from the Wi-Fi (registered trademark) base station. When the position information cannot be acquired, the position and direction acquisition unit 120 may acquire the position information on the mobile terminal 100 using the geomagnetic sensor.

In the embodiment, an example is described in which the position and direction acquisition unit 120 uses the GPS to acquire the current position of the mobile terminal 100 outdoors. Alternatively, the position and direction acquisition unit 120 may use another satellite positioning system such as a quasi-zenith satellite system. Alternatively, the position and direction acquisition unit 120 may acquire the current position of the mobile terminal 100 using the GPS and the quasi-zenith satellite system.

### B9. Other Embodiment 9

In the embodiment, the storage unit 110 stores the sound source data including the sound signal obtained by reading out the description information about the target that can be a target visually recognized by the user. However, the sound source data may not be stored in the storage unit 110. The information output unit 160 may access sound source data stored in a cloud server and transmit a sound signal included in the sound source data to the earphone 200. In this case, a uniform resource locator (URL) for identifying a position of the sound source data stored in the cloud server may be stored in the storage unit 110.

### B10. Other Embodiment 10

In the embodiment, an example is described in which the description information provided to the user is any one of three types of description information including the normal description information, the detailed description information, and the simple description information. However, the number of types of description information is not limited to three. Alternatively, one of two types of description information, that is, the normal description information and the simple description information, may be provided to the user. Alternatively, the number of types of description information may be four or more.

In the embodiment, an example is described in which the three types of description information are the normal description information, the detailed description information, and the simple description information. As the description information, different types of description information may be provided according to ages of users. For example, any one of a type of description information provided to elementary school-age users, a type of description information provided to middle school and high school users, and a type of description information provided to college students and adult users may be provided in accordance with the ages of the users. For example, when the guidance application is installed, the information provision system 1000 determines an age group of the users based on age information input by the user. Each type of description information has contents that can be understood by the user in accordance with the age. Further, the normal description information, the detailed description information, and the simple description information are prepared for each age-based type of user.

Alternatively, for an identified target, one of the description information of three types of description information may be provided to the user, and for another target, one of the description information of two types of description information may be provided to the user.

In the embodiment, the earphone 200 is described as an example of a sound output device, and the sound output device may be a headphone or a bone conduction headset.

In the embodiment, an example is described in which the communication unit 103 communicates with the external device according to the communication standard of Wi-Fi (registered trademark). However, the communication unit 103 may communicate with the external device according to another communication standard such as Bluetooth (registered trademark). The communication unit 103 may support a plurality of communication standards.

A component for implementing the functions of the mobile terminal 100 is not limited to software, and part or all of the functions may be implemented by dedicated hardware. For example, as the dedicated hardware, a circuit represented by a field programmable gate array (FPGA) or an application specific integrated circuit (ASIC) may be used.

In the embodiment, an example is described in which the mobile terminal 100, which is a computer carried by the user, is a smartphone. Alternatively, the mobile terminal 100 may be a mobile phone, a tablet terminal, or the like. Alternatively, the mobile terminal 100 may be a wearable computer. The wearable computer is, for example, a smart watch, and a head mount display.

In the embodiment, when the information output unit 160 determines that the information-provision-related setting data is updated based on the notification from the intention estimation unit 150, the information output unit 160 interrupts the output of the description information. However, the information output unit 160 may not necessarily interrupt the output of the description information. For example, the information output unit 160 may read the updated setting data while continuing to output the description information by sound, and then output the description information in accordance with the information-provision-related setting data after the update.

When the rotation about the roll axis is detected, the information output unit 160 may interrupt the output of the description information, and may re-output a part of the description information output immediately before according to the information-provision-related setting data after the update. When the rotation about the yaw axis or the rotation about the pitch axis is detected, the information output unit 160 may switch, for example, the description information to be provided to the detailed description information or the simple description information according to the information-provision-related setting data after the update without interrupting the output of the description information.

Regardless of the estimated intention of the user based on the motion of the head of the user, which of the three types of description information is to be provided may be selected. For example, outputting, by sound, the description information for a long time in hot or cold weather outdoors may be a factor to keep the user outdoors. In such a case, for example, the selection may be made to provide the simple description information based on the date and time and the position information.

The head motion detection unit 140 may detect the roll angle, the pitch angle, and the yaw angle based on the measurement value of the acceleration, the measurement value of the angular velocity, and the measurement value of a geomagnetic intensity. In this case, the sensor 203 includes a geomagnetic sensor in addition to the acceleration sensor, the angle sensor, and the angular velocity sensor.

The present disclosure is not limited to the above-described embodiments, and can be implemented by various configurations without departing from the gist of the present disclosure. For example, the technical features in the embodiments corresponding to the technical features in the aspects described in “Summary of Invention” can be appropriately replaced or combined in order to solve a part or all of the problems described above or in order to achieve a part or all of the effects described above. Any of the technical features may be omitted as appropriate unless the technical feature is described as essential herein.

What is claimed is:

1. An information provision system configured to provide information by sound, the information provision system comprising:
a processor; and
a memory storing instructions that, when executed by the processor, cause the information provision system to perform operations, the operations comprising:
acquiring position information indicating a position where a user is present and line-of-sight direction information indicating a line-of-sight direction corresponding to a direction in which a face of the user faces;
estimating a target visually recognized by the user based on the position information, the line-of-sight direction information, and target position information set in advance for each of a plurality of targets that are possible targets visually recognizable by the user;
outputting, by sound, description information about the target in accordance with a setting related to information provision;
detecting a motion of a head of the user;
estimating an intention of the user based on the motion of the head of the user during output of the description information;
selecting the setting in accordance with the intention of the user; and
outputting, in response to change of the setting, the description information in accordance with the setting after the change.

2. The information provision system according to claim 1,
wherein the description information includes first description information that is a description for the plurality of targets and second description information that is a description for the plurality of targets different from the first description information, and
wherein the setting includes information indicating which of the first description information and the second description information is selected as the description information.

3. The information provision system according to claim 2,
wherein the description information further includes third description information that is a description for the plurality of targets different from the first description information and the second description information,
wherein the first description information is a normal description for the plurality of targets, the second description information is a description more detailed than the first description information, and the third description information is a description simpler than the first description information, and
wherein the setting includes information indicating which of the first description information, the second description information, and the third description information is selected as the description information.

4. The information provision system according to claim 1,
wherein the setting includes setting information related to sound output.

5. The information provision system according to claim 1,
wherein the setting includes information indicating whether to continue output of the description information.

6. The information provision system according to claim 1,
wherein the operations further comprise:
outputting a question for the user by sound; and
estimating an answer of the user to the question based on the motion of the head of the user.

7. The information provision system according to claim 1,
wherein the plurality of targets include a moving object, and
wherein the operations further comprise estimating that, in a case in which a state in which the moving object is present in a range in which eyes of the user can see continues for a preset period, the moving object is the target visually recognized by the user.

8. The information provision system according to claim 1,
wherein the operations further comprise:
acquiring a virtual position of a sound source corresponding to each of the plurality of targets,
outputting, from a portable sound output device mountable on the head of the user, and in accordance with a virtual position of the sound source as viewed from a current position of the user, sound obtained by performing a stereophonic sound process on sound representing the description information.

9. The information provision system according to claim 1,
the operations further comprise:
acquiring intention definition data which defines a non-verbal motion corresponding to a culture to which a language to be used by the user belongs, and
estimating the intention of the user based on the intention definition data and the motion of the head of the user.

10. The information provision system according to claim 1,
wherein the operations further comprise estimating the intention of the user by inputting, to a learned machine learning model, a parameter representing the motion of the head of the user, a moving speed of the user, a distance between the user and the target, and a relative angle of the user with respect to the target.

11. A method for providing information by sound using a computer carriable by a user, the method comprising:
acquiring position information indicating a position where the user is present and line-of-sight direction information indicating a line-of-sight direction corresponding to a direction in which a face of the user faces;
estimating a target visually recognized by the user based on the position information, the line-of-sight direction information, and target position information set in advance for each of a plurality of targets that are possible targets visually recognizable by the user;
outputting, by sound, description information for the target in accordance with a setting related to information provision;
detecting a motion of a head of the user;
estimating an intention of the user based on the motion of the head of the user during output of the description information;
selecting the setting in accordance with the intention of the user; and
outputting, in response to change of the setting, the description information by the sound in accordance with the setting after the change.

12. A non-transitory computer-readable medium storing a computer program, the computer program that, when executed by a processor, causes a computer carriable by a user to perform operations, the operations comprising:
acquiring position information indicating a position where the user is present and line-of-sight direction information indicating a line-of-sight direction corresponding to a direction in which a face of the user faces;
estimating a target visually recognized by the user based on the position information, the line-of-sight direction information, and target position information set in advance for each of a plurality of targets that are possible targets visually recognizable by the user;
outputting, by sound, description information for the target in accordance with a setting related to information provision;
detecting a motion of a head of the user;
estimating an intention of the user based on the motion of the head of the user during output of the description information;
selecting the setting in accordance with the intention of the user; and
outputting, in response to change of the setting, the description information by the sound in accordance with the setting after the change.
